(19) United States
(12) Patent Application Publication
(10) Pub. No.: US 2006/0241915 A1
(43) Pub. Date: Oct. 26, 2006

(54) Quadrature phase-shifting timebase system

(76) Inventors: Mark Joseph Woodward, Santa Rosa, CA (US); James R. Stimple, Santa Rosa, CA (US); Willard MacDonald, Bolinas, CA (US); Jady Palko, Windsor, CA (US)

Correspondence Address: AGILENT TECHNOLOGIES, INC.;Intellectual Property Administration, Legal Department, DL 429, P.O. Box 7599, Loveland, CO, 80537-0599, US

(21) Appl. No.: 11/101,729

(22) Filed: Apr. 8, 2005

(51) Int. Cl. G06F 15/00

(52) U.S. Cl. 702/189

(57) ABSTRACT

A system includes providing a first signal in response to a received signal that has a first timing relationship to an applied signal, adjusting the phase of the first signal to provide a second signal, receiving the second signal and generating a strobe based on a counted number of cycles of the second signal, wherein the strobe has a second timing relationship to the applied signal that is based on the counted number of cycles of the second signal.

### BACKGROUND OF THE INVENTION

Timebases establish timing of sample acquisitions in sampling oscilloscopes and other measurement systems. Timebases in commercially available sampling oscilloscopes typically use trigger and delay circuits to control the timing of sample acquisitions by the sampling oscilloscopes. For example, a timebase disclosed in U.S. Pat. No. 5,595,479 provides for sample acquisitions at designated delays relative to a trigger event, with a fine delay generator establishing the accuracy of the delays. However, noise and transient responses of the fine delay generator can cause timing jitter and timing inaccuracies in waveforms that are reconstructed from samples that are acquired using the timebase. For example, jitter of one picosecond and timing errors of greater than one picosecond are typical for this type of timebase. The transient responses of the fine delay generator can also result in a recovery time and a settling time for the timebase that limit the rate of sample acquisitions that can be achieved using this type of prior art timebase.

Another prior art timebase is disclosed by Jungerman et al. in U.S. Pat. No. 6,564,160B2. In this timebase, a pair of samplers acquires quadrature samples of a reference sine wave according to an oscillator that is not synchronized with the reference sine wave or an applied measurement signal. To reconstruct waveforms of the applied measurement signal, the timebase maps amplitudes of the acquired quadrature samples to timing information. While this timebase provides for reconstructed waveforms that have low jitter and high timing accuracy when used in a sampling oscilloscope, the timing of sample acquisitions of the applied measurement signal is random due to the lack of synchronization between the oscillator and the applied measurement system. Therefore, when this prior art timebase is included in a sampling oscilloscope, the samples of the applied measurement signal can not be acquired at designated or specified times. The random timing of sample acquisitions also results in inefficient sampling in measurement applications that involve sampling windows that have narrow time duration.

In view of the shortcomings of the prior art timebases, there is a need for a timebase system that can provide low jitter and high timing accuracy, while enabling samples to be acquired at designated or specified times.

### BRIEF DESCRIPTION OF THE DRAWINGS

FIG. 1 shows a block diagram of a timebase system according to embodiments of the present invention.

FIG. 2 shows a block diagram of a quadrature phase shifter suitable for inclusion in the timebase system shown in FIG. 1.

FIGS. 3A-3B show examples of signals provided by the quadrature phase shifter shown in FIG. 2.

FIG. 4 shows a timing diagram for the timebase system according to embodiments of the present invention.

FIG. 5 shows a comparison of timing error for samples acquired using a prior art timebase and for samples acquired using the timebase system shown in FIG. 1.

FIGS. 6A-6B show a comparison of jitter for samples acquired using the prior art timebase and for samples acquired using the timebase system shown in FIG. 1.

### DETAILED DESCRIPTION

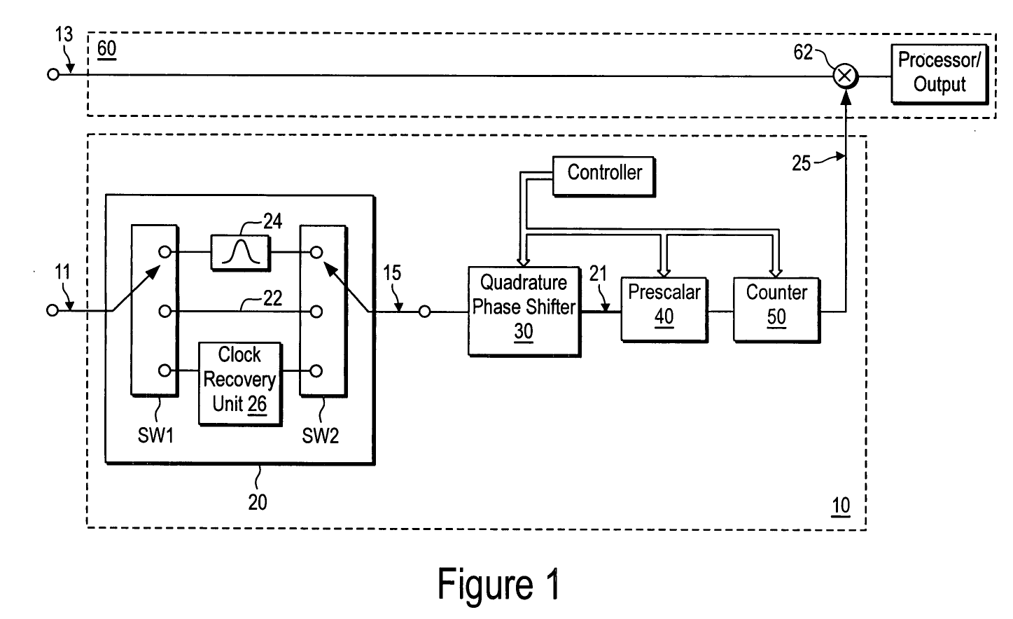

FIG. 1 shows a block diagram of a timebase system 10 according to embodiments of the present invention. The timebase system 10 includes a signal conditioner 20, a quadrature phase shifter 30, a prescalar 40, and a counter 50. In a typical application of the timebase system 10, the timebase system 10 is used in conjunction with a sampling system 60 with the counter 50 coupled to a sampler 62 as shown. In FIG. 1, the prescaler 40 is interposed between the quadrature phase shifter 30 and the counter 50 to enable the timebase system 10 to accommodate signals that have high frequencies.

In one example of the timebase system 10, the signal conditioner 20 includes switches SW1, SW2 that provide coupling to three alternative signal paths. One of the signal paths includes a through line 22, one of the signal paths includes a filter 24, and one of the signal paths includes a clock recovery unit 26. The signal paths can be selected via the switches SW1, SW2, typically based on the type of signal 11 that is applied to the timebase system 10. In alternative examples, the signal conditioner 20 includes a through path 22, a filter 24, or a clock recovery unit 26 in a non-switched arrangement. The signal conditioner 20 can also include any other combination of the through path 22, the filter 24, and the clock recovery unit 26 in a switched arrangement. The signal conditioner 20 alternatively includes other types of components, elements or systems to accommodate attributes of the signals 11 that are provided to the timebase system 10.

In typical applications of the timebase system 10, the signal 11 has an established timing relationship to a signal 13 that is applied to the sampling system 60. For example, when the signal 13 is a data signal and the signal 11 is the clock of the data signal 13, the signal 11 is synchronous with the signal 13. When the signal 11 that is applied to the timebase system 10 is also the signal 13 that is applied to the sampling system 60, i.e. when the same signal is applied to the timebase system 10 and the sampling system 60, the signal 11 and the signal 13 have identical timing to within a timing offset due to path differences between the sampling system 60 and the timebase system 10. When the signal 11 that is applied to the timebase system 10 and the signal 13 applied to the sampling system 60 are two data signals at different data rates and are derived from a common clock, the signal 11 and the signal 13 have an established timing relationship via the common clock. In typical applications of the timebase system 10, the clock has a fundamental frequency relationship, a harmonic frequency relationship, a subharmonic frequency relationship, or other rational frequency relationship to the data signal. The examples presented illustrate several of the many types of signals 11, 13 that have established timing relationships and that are suitable for application to the timebase system 10 and the sampling system 60.

In the example of the signal conditioner 20 that is shown in FIG. 1, when the signal 11 is sinusoidal, such as a sinusoidal clock, the switches SW1, SW2 are typically set to a position that selects the signal path that includes the through line 22. This results in a conditioned signal 15 that is sinusoidal being provided to the quadrature phase shifter 30. When the signal 11 is a clock or other timing signal that has multiple frequency components, the switches SW1, SW2 are typically set to a position that selects the signal path that includes the filter 24. The filter 24 is typically a single filter or a bank of selectable filters that extracts a sinusoidal component of the signal 11 so that the conditioned signal 15 provided to the quadrature phase shifter 30 is sinusoidal. When the signal 11 is a data signal, the switches SW1, SW2 are typically set to a position that selects the signal path that includes the clock recovery unit 26. The clock recovery unit 26 extracts a clock from the data signal and filters the clock to provide a conditioned signal 15 to the quadrature phase shifter 30 that is sinusoidal. Alternative selections of signal paths in the signal conditioner 20 can be made based on the attributes of the signals 11, 13 or based on the use or application of the timebase system 10.

In one example of the signal conditioner 20, the clock recovery unit 26 includes an AGILENT TECHNOLOGIES, INC. model 83496A Clock Recovery Module cascaded with a filter or one or more selectable filters (not shown). In alternative examples, the clock recovery unit 26 includes a phase-locked loop (PLL) suitable for recovering a clock from the signal 11 that is applied to the timebase system 10. The loop bandwidth of the PLL can be specified according to communication signal standards, such as the IEEE 802.3 or the INCITS MJSQ standards, or according to other standards or designated criteria. In one example, the PLL is configured to enable the clock recovery unit 26 to recover a clock having frequency components with a harmonic frequency relationship, a subharmonic frequency relationship, or other rational frequency relationship to the signal 11 that is applied to the timebase system 10. The filter or the one or more selectable filters can be configured to extract a designated frequency component of the recovered clock to provide a conditioned signal 15 to the quadrature phase shifter 30 that is sinusoidal.

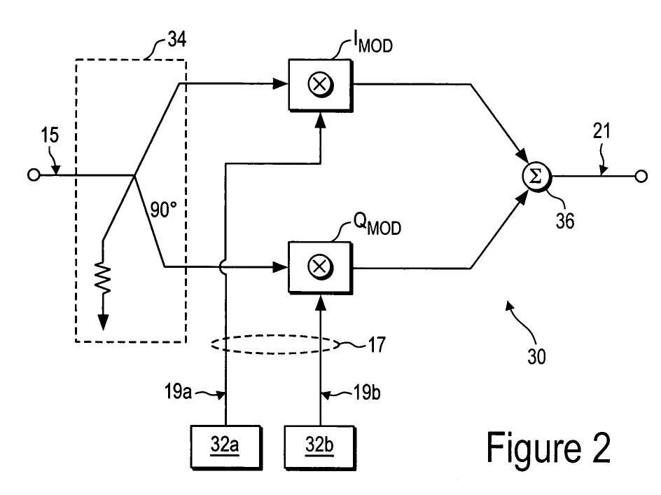

FIG. 2 shows a block diagram of a quadrature phase shifter 30 suitable for inclusion in the timebase system 10. The quadrature phase shifter 30 receives a sinusoidal signal or other suitably conditioned signal 15 provided by the signal conditioner 20 (shown in FIG. 1) and shifts the phase of the conditioned signal 15 according to a control signal 17 to provide a signal 21. In the example shown in FIG. 2, the control signal 17 includes an I-signal (in-phase signal) 19a that is provided by a phase DAC (digital-to-analog converter) 32a, and a Q-signal (quadrature-phase signal) 19b that is provided by a phase DAC 32b. The quadrature phase shifter 30 typically includes a quadrature coupler 34, an in-phase modulator IMOD in an in-phase coupled path of the quadrature coupler 34, and a quadrature-phase modulator QMOD in a quadrature coupled path of the quadrature coupler 34. The I-signal 19a and the Q-signal 19b are applied to the modulators I_{MOD}, Q_{MOD}, respectively. Resulting modulated signals provided by the modulators I_{MOD}, Q_{MOD}, are vector summed via an output summer 36 or other signal combiner that is included in the quadrature phase shifter 30. Varying one or both of the I-signal 19a and the Q-signal 19b, via the corresponding phase DAC 32a and phase DAC 32b, causes corresponding phase shifts in the signal 21 that is provided by the quadrature phase shifter 30. Static adjustments, stepped adjustments, sinusoidal adjustments, or other time-varying adjustments to the I-signal 19a and/or the Q-signal 19b provide a variety of types of phase modulation to the signal 21.

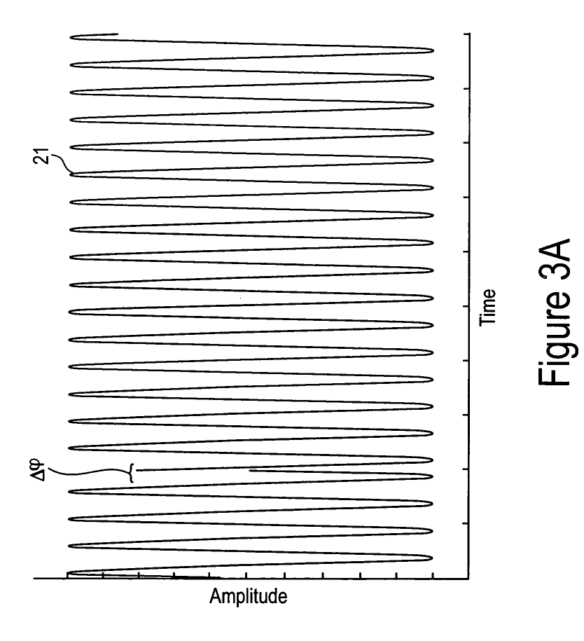

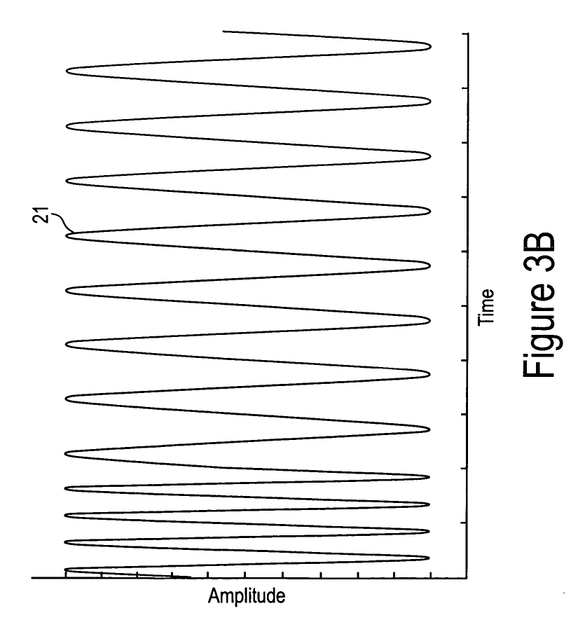

In one example, the I-signal 19a and the Q-signal 19b provide a stepped control signal 17 to the modulators I_{MOD}, Q_{MOD}. The stepped control signal 17 results in a corresponding phase shift Δφ to the signal 21, as shown in the example waveform of the signal 21 in FIG. 3A. For the purpose of illustration, the phase shift Δφ is shown to occur instantaneously, within a cycle of the signal 21. However, due to the finite response time of the phase DACs 32a, 32b that provide the I-signal 19a and the Q-signal 19b, respectively, the resulting phase shift Δφ typically occurs after a phase transition (not shown) that has a time duration that is greater than one cycle of the signal 21.

The I-signal 19a and the Q-signal 19b can also provide a time-varying control signal 17 to the modulators I_{MOD}, Q_{MOD}. In one example, the phase DACS 32a, 32b provide a sinusoidal I-signal 19a and a cosinusoidal Q-signal 19b that have equal frequency f. This time-varying control signal 17 causes the signal 21 to have a frequency shift, relative to the conditioned signal 15, which is equal to the frequency f. FIG. 3B shows one example of a waveform of the signal 21, shifted in frequency according to the frequency f of the sinusoidal I-signal 19a and the cosinusoidal Q-signal 19b. For the purpose of illustration, the frequency shift of the signal 21 is shown to occur instantaneously, within a cycle of the conditioned signal 15. However, due to the finite response time of the phase DACs 32a, 32b, the resulting frequency shift in the signal 21 typically occurs after a phase transition (not shown) of the conditioned signal 15 that has a time duration that is greater than one cycle of the conditioned signal 15.

As shown in FIG. 1, the counter 50 receives the signal 21 from the quadrature phase shifter 30. When the frequency of the signal 21 exceeds the frequency range that can be accommodated by the counter 50, a frequency divider, or prescaler 40, can be interposed between the quadrature phase shifter 30 and the counter 50. The prescaler 40 divides the frequency of the signal 21 to provide a frequency-divided signal to the counter 50 that is within the frequency range of the counter 50. When the frequency of the signal 21 is within the frequency range of the counter 50, the prescaler 40 can be omitted from the timebase system 10.

The counter 50 counts a designated number of cycles of the signal 21, and generates a strobe 25 that is based on the counted number of cycles of the signal 21. The strobe 25 is typically provided upon the occurrence of a terminal count of the counter 50. A programmable counter, such as an ONSEMICONDUCTOR model MC10E016, from SEMICONDUCTOR COMPONENTS INDUSTRIES, LLC., enables the counted number of cycles of the signal 21 to be adjusted, typically by programming the start count of the counter 50 to be the terminal count of the counter 50 minus the designated number of cycles to be counted. Adjusting the counter 50 correspondingly varies the number of cycles of the signal 21 that occur between the generated strobes 25.

Adjusting the counter 50 enables the time intervals between strobes 25 to be varied in time increments that are equivalent to the duration of one cycle of the signal 21. By adjusting the quadrature phase shifter 30, the time intervals between strobes 25 can be varied by correspondingly adjustable time increments. The phase-shift adjustment range of the quadrature phase shifter 30 is sufficient to accommodate phase shifts over a wide adjustment range, providing for a wide range of adjustment to the timing of the strobe 25.

In one example application of the timebase system 10, the strobe 25 is provided to a sampler 62 of a sampling system 60 (shown in FIG. 1), wherein the strobe 25 designates the timing of sample acquisitions by the sampler 62. Typically, the quadrature phase shifter 30 and/or the counter 50 are adjusted or programmed between the sample acquisitions to adjust the timing of the sample acquisitions by the sampler 62. The quadrature phase shifter 30 and the counter 50 enable the timing of sample acquisitions of the signal 13 by the sampling system 60 to be specified, controlled, or otherwise designated.

When the quadrature phase shifter 30 induces a phase shift Δφ in the phase-shifted signal 21 as shown in the example waveform of FIG. 3A, the strobe 25 modifies the timing of the sample acquisitions by the sampling system 60 by a time Δt, which is equal to the phase shift Δφ divided by the frequency of the conditioned signal 15. When the quadrature phase shifter 30 shifts the phase of the strobe 25 according to a sinusoidal I-signal 19a and cosinusoidal Q-signal 19b as shown in the example waveform of FIG. 3B, the resulting signal 21 is offset in frequency from the conditioned signal 15. Due to the offset in frequency, the resulting strobe 25 that is applied to the samples 62 causes a precession or progressive variation in the timing of the sample acquisitions of the signal 13 by the sampling system 60.

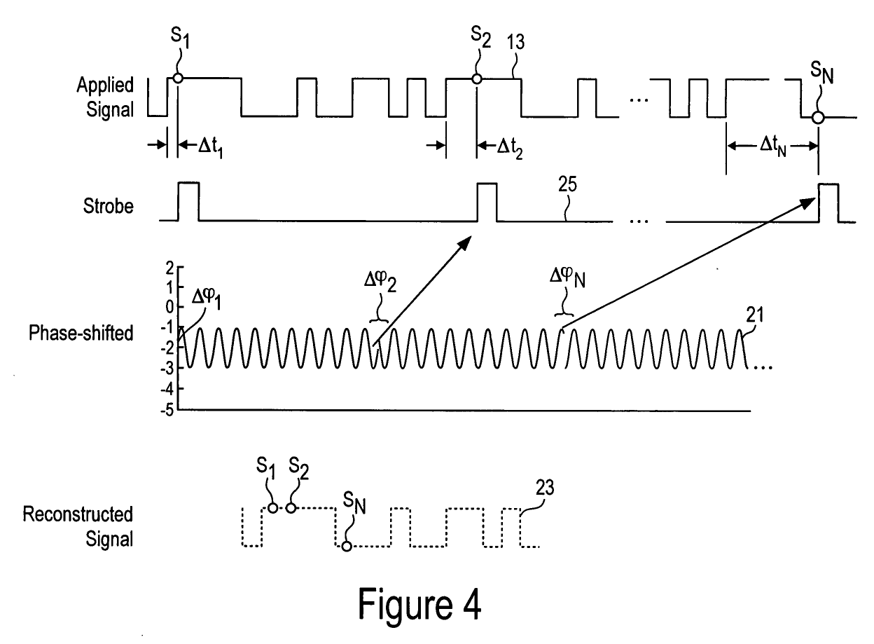

FIG. 4 shows one example of a timing diagram for the timebase system 10 configured with a sampling system 60 to provide sample acquisitions of the signal 13 that is applied to the sampling system 60. In FIG. 4, the signal 13 is shown reconstructed from acquired samples S₁, S₂ . . . S_{N} as a reconstructed signal 23. The acquired samples S₁, S₂. . . S_{N} in the reconstructed signal 23 are timed according to the strobe 25, which has a timing relationship to the signal 13 that is based on the counted number of cycles of the signal 21. In the example timing diagram shown in FIG. 4, the I-signal 19a and the Q-signal 19b provide a series of stepped control signals to the quadrature phase shifter 30 that cause a series of phase shifts Δφ₁, Δφ₂ . . . Δφ_{N} to the signal 21. When the cycles of the signal 21 are counted by the counter 30, the timing of the resulting strobe 25 is varied according to the phase shifts Δφ₁, Δφ₂ . . . Δφ_{N} by time intervals Δt₁, Δt₂ . . . Δt₃. This variation in the timing of the strobe 25, due to the phase shifts Δφ₁, Δφ₂ . . . Δφ_{N} provided by the quadrature phase shifter 30, causes samples to be acquired at different positions within subsequent cycles of the signal 13. This provides for a suitable distribution of the timing of the acquired samples S₁, S₂ . . . S_{N} in the reconstructed signal 23.

Because the timebase system 10 generates the strobe 25 based on the counted number of cycles of the conditioned signal 15, as phase-shifted by the quadrature phase shifter 30 to provide the phase-shifted signal 21, timing relationships between the strobe 25, the signal 11, and the signal 13 are maintained by the timebase system 10 when the timebase system 10 is used in conjunction with a sampling system 60.

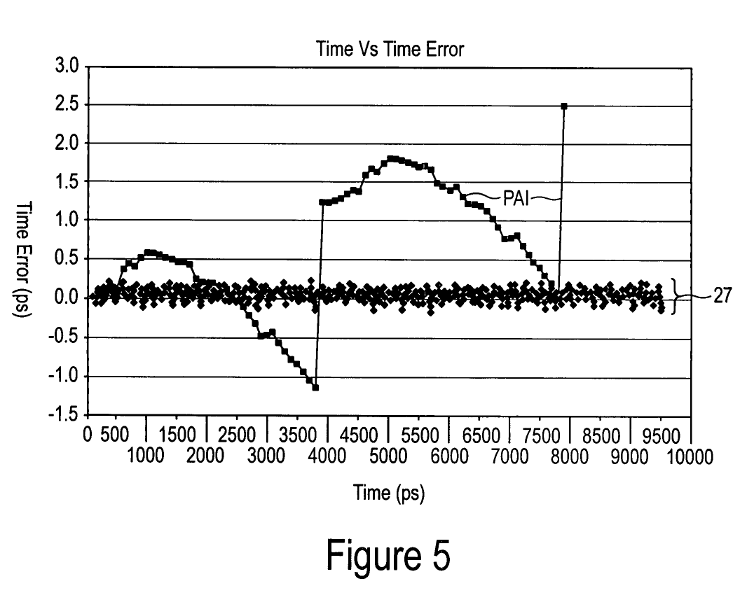

FIG. 5 shows a plot 27 of timing error for samples that are acquired using the timebase system 10 in conjunction with the sampling system 60. The plot 27 indicates that the timing accuracy of the samples that are acquired with the timebase system 10 is within a timing error of approximately 0.4 picoseconds. FIG. 5 also shows a plot PA1 of timing error for samples that are acquired using a prior art timebase. The prior art timebase has a transient response that results in a surge in the timing error that exceeds 1.5 picoseconds, which decreases the timing accuracy of the prior art timebase.

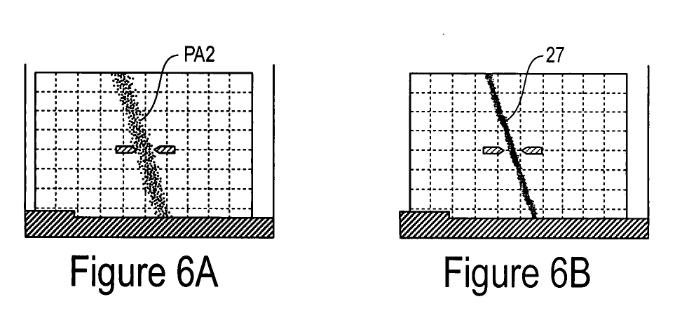

FIG. 6A shows jitter for a reconstructed signal PA2 from samples acquired using the prior art timebase. FIG. 6B shows the a reconstructed signal 23 from samples acquired using the timebase system 10 shown in FIG. 1. A comparison of the plots PA2, 23 indicates that when configured with a sampling system 60, the timebase system 10 provides for lower jitter than the prior art timebase.

While the embodiments of the present invention have been illustrated in detail, it should be apparent that modifications and adaptations to these embodiments may occur to one skilled in the art without departing from the scope of the present invention as set forth in the following claims.

1. A system, comprising:
a signal conditioner providing a first signal in response to a received signal that has a first timing relationship to an applied signal;
a quadrature phase shifter adjusting the phase of the first signal according to a control signal to provide a second signal; and
a counter receiving the second signal and generating a strobe based on a counted number of cycles of the second signal, the strobe having a second timing relationship to the applied signal that is based on the counted number of cycles of the second signal.

2. The system of claim 1 further comprising a sampler receiving the applied signal and acquiring a set of samples of the applied signal according to the strobe.

3. The system of claim 1 wherein the received signal is a clock associated with the applied signal.

4. The system of claim 3 wherein the signal conditioner includes a filter selecting a sinusoidal signal component of the received signal so that the first signal is sinusoidal.

5. The system of claim 1 wherein the applied signal is coupled to the signal conditioner to provide the received signal.

6. The system of claim 5 wherein the signal conditioner includes a clock recovery unit that provides the first signal, wherein the first signal is sinusoidal.

7. The system of claim 1 wherein the received signal and the applied signal are derived from a common clock.

8. The system of claim 1 wherein the signal conditioner is configurable to include one of a filter, a clock recovery unit, and a through path, in a signal path between an input that receives the received signal and an output that is coupled to the quadrature phase shifter.

9. The system of claim 2 wherein the signal conditioner is configurable to include one of a filter, a clock recovery unit, and a through path, in a signal path between an input that receives the received signal and an output that is coupled to the quadrature phase shifter.

10. The system of claim 1 wherein the counter generates the strobe upon the occurrence of a terminal count.

11. The system of claim 2 wherein the counter generates the strobe upon the occurrence of a terminal count.

12. A system, comprising:
providing a first signal in response to a received signal that has a first timing relationship to an applied signal;
adjusting the phase of the first signal according to a control signal to provide a second signal; and
receiving the second signal and generating a strobe based on a counted number of cycles of the second signal, the strobe having a second timing relationship to the applied signal that is based on the counted number of cycles of the second signal.

13. The system of claim 12 further comprising receiving the applied signal and acquiring a set of samples of the applied signal according to the strobe.

14. The system of claim 12 wherein the received signal is a clock associated with the applied signal.

15. The system of claim 12 wherein providing the first signal includes selecting a sinusoidal signal component of the received signal so that the first signal is sinusoidal.

16. The system of claim 12 wherein the applied signal provides the received signal.

17. The system of claim 12 wherein a clock recovery unit provides the first signal, wherein the first signal is sinusoidal.

18. The system of claim 12 wherein the received signal and the applied signal are derived from a common clock.

19. The system of claim 12 wherein a counter generates the strobe upon the occurrence of a terminal count.

20. The system of claim 13 wherein a counter generates the strobe upon the occurrence of a terminal count.
